(19) United States
(12) Patent Application Publication
(10) Pub. No.: US 2007/0044009 A1
(43) Pub. Date: Feb. 22, 2007

(54) INFORMATION PROCESSING APPARATUS AND METHOD

(75) Inventor: MOMOE TOKUNAGA, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/462,431

(22) Filed: Aug. 4, 2006

(30) Foreign Application Priority Data
Aug. 5, 2005 (JP) 2005-228474

(51) Int. Cl. G06F 17/00

(52) U.S. Cl. 715/500

(57) ABSTRACT

According to an information processing method of generating a flow by coupling a plurality of processes, one of the plurality of processes is set by referring to a memory in which process information for defining input data and output data of each of the plurality of processes is registered, in order to generate a flow. Processes capable of outputting input data of the set process are acquired as candidate processes from the plurality of processes by referring to the process information in the memory. The acquired candidate processes are presented. A selected candidate process is connected as a process at the previous stage of the set process in accordance with an operation to select one of the presented candidate processes.

### BACKGROUND OF THE INVENTION

1. Field of the Invention

The present invention relates to creation of an executable job flow by coupling a plurality of processes.

2. Description of the Related Art

Japanese Patent Application Laid-Open No. 2004-287859 discloses a service processing apparatus which can set a job flow by series- or parallel-combining processes such as Fax transmission, a scanner process, and a print process to be performed for document data. The service processing apparatus can use devices connected to a network to process document data in accordance with a job flow prepared by coupling these processes.

The service processing apparatus in Japanese Patent Application Laid-Open No. 2004-287859 can couple a plurality of processes and series- or parallel-execute them with devices connected to a network. However, the service processing apparatus cannot create and execute a job flow for continuing another process after the parallel processes. For example, the service processing apparatus in Japanese Patent Application Laid-Open No. 2004-287859 does not consider creation of a job flow in which a process to receive two results obtained by parallel-executing two processes is connected to the next stage of the parallel processes.

It is expected that there are many processes requiring a plurality of inputs among processes available to create a job flow. In this case, it is difficult to create a job flow containing complicated parallel processes by paying attention to connectivity between tasks.

### SUMMARY OF THE INVENTION

The present invention has been made to overcome the conventional drawbacks, and has as its object to make it possible to easily create a complicated job flow to continue, after parallel processes, a process using a plurality of results obtained by the parallel processes.

According to one aspect of the present invention, there is provided an information processing apparatus which generates a flow by coupling a plurality of processes, comprising: a registration unit adapted to register process information for defining input data and output data of each of the plurality of processes; a setting unit adapted to set one of the plurality of processes as a set process in order to generate a flow; an acquisition unit adapted to acquire, as candidate processes from the plurality of processes, processes capable of outputting input data of the set process by referring to the process information; a presenting unit adapted to present the candidate processes acquired by the acquisition unit; and a connection unit adapted to connect a selected candidate process as a process at a previous stage of the process in accordance with an operation to select one of the candidate processes presented by the presenting unit.

According to another aspect of the present invention, there is provided an information processing method of generating a flow by coupling a plurality of processes, comprising the steps of: setting one of the plurality of processes as a set process by referring to a memory in which process information for defining input data and output data of each of the plurality of processes is registered, in order to generate a flow; acquiring, as candidate processes from the plurality of processes, processes capable of outputting input data of the set process by referring to the process information; presenting the candidate processes acquired in the acquisition step; and a connection step of connecting a selected candidate process as a process at a previous stage of the process in accordance with an operation to select one of the candidate processes presented in the presenting step.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing the system configuration of a service cooperation processing system according to an embodiment;

FIGS. 2A and 2B are views each showing an operation flow from addition of an application up to execution of a job flow in the service cooperation processing system according to the embodiment;

FIG. 3 is a view showing an example of the data structure of task definition information according to the embodiment;

FIG. 4A is a view schematically showing job flow definition information according to the embodiment;

FIG. 4B is a view showing an example of the XML description of the job flow definition information illustrated in FIG. 4A;

FIG. 5A is a view showing an example of icon display of a task according to the embodiment;

FIG. 5B is a table showing an example of the input/output data definition of a task according to the embodiment;

FIGS. 6A and 6B are views showing an example of the user interface of a job flow creation editor according to the embodiment;

FIG. 7 is a view showing an outline of a cooperative application in concrete example 1 of the embodiment;

FIG. 8 is a view showing a display example of the task icon of a task in the cooperative application in example 1;

FIG. 9A is a view showing an example of the data structure of task definition information in example 1;

FIG. 9B is a view showing an example of the data structure of task definition information of a master selection task in example 1;

FIG. 10 is a view showing an example of categorizing tasks in example 1;

FIGS. 11A to 11C are views for explaining job flow creation procedures in example 1;

FIG. 12 is a flowchart showing the whole process of job flow creation according to the embodiment;

FIG. 13 is a flowchart showing a task search & display & selection process in job flow creation according to the embodiment;

FIG. 14 is a table showing an example of the input/output data definition of a task in example 1;

FIG. 15 is a view showing an outline of a cooperative application in concrete example 2 of the embodiment;

FIG. 16 is a view showing a display example of the task icon of a task in the cooperative application in example 2;

FIG. 17 is a view showing an example of the data structure of task definition information of a Cc boss designation task in example 2;

FIG. 18 is a view for explaining hierarchical management of categories in example 2;

FIG. 19 is a view showing an example of categorizing tasks in example 2;

FIGS. 20A to 20C are views for explaining job flow creation procedures in example 2;

FIG. 21 is a table showing an example of the input/output data definition of a task in example 2;

FIG. 22 is a view showing an outline of a cooperative application in concrete example 3 of the embodiment;

FIG. 23 is a view showing a display example of the task icon of a task in the cooperative application in example 3;

FIG. 24 is a view showing an example of the data structure of task definition information of a key acquisition task in example 3;

FIG. 25 is a view showing an example of categorizing tasks in example 3;

FIGS. 26A to 26D are views for explaining job flow creation procedures in example 3; and

FIG. 27 is a table showing an example of the input/output data definition of a task in example 3.

### DESCRIPTION OF THE EMBODIMENTS

Preferred embodiments of the present invention will now be described in detail in accordance with the accompanying drawings.

A system configuration and application configuration according to the embodiment will be explained.

<System Configuration>

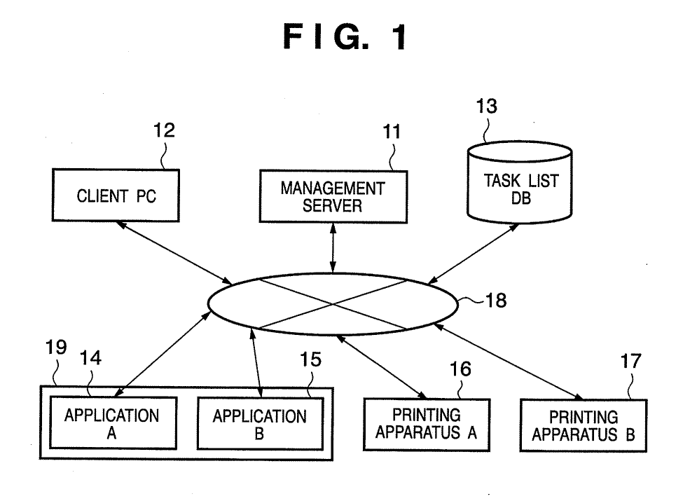

FIG. 1 shows the overall configuration of a task cooperation processing system according to the embodiment. The task cooperation processing system can couple various tasks containing tasks of a printing apparatus and cause the printing apparatus to execute the tasks.

Note that a task in the embodiment means a process executable for document data. For example, tasks of the printing apparatus are copying of document data, scan, Fax transmission, save in the internal hard disk of the printing apparatus, mail sending, and the like. Needless to say, tasks applicable to the present invention are not limited to them. The task cooperation processing system can also cooperate with a plurality of applications capable of providing various tasks, in addition to the printing apparatus which provides the above tasks. In the embodiment, a printing apparatus capable of executing a task and an information processing apparatus for executing a task are defined as task processing apparatuses. Note that the apparatus which executes an application capable of executing a task is an information processing apparatus such as a personal computer.

As shown in FIG. 1, the task cooperation processing system according to the embodiment comprises a management server 11, client PC 12, task list DB 13, application A 14, application B 15, printing apparatus A 16, and printing apparatus B 17, which are connected by a network 18. The application A 14 represents application A executed by an information processing apparatus 19, whereas the application B 15 represents application B executed by the information processing apparatus 19. The number of applications and that of printing apparatuses are not limited to those shown in FIG. 1. The task list DB 13 can take any form such that it is prepared for each application or is managed separately from task management of the printing apparatus. Information processing apparatuses which execute the application A 14 and application B 15 may be different. However, as shown in FIG. 1, a task cooperation processing system will be explained in which two applications (application A 14 and application B 15) and two printing apparatuses (printing apparatus A 16 and printing apparatus B 17) are connected.

The management server 11 manages task processing apparatuses such as the application A 14, application B 15, printing apparatus A 16, and printing apparatus B 17, and manages tasks executable by the respective task processing apparatuses in the task list DB 13. The client PC 12 acquires desired executable tasks via the management server 11 from tasks registered in the task list DB 13, and creates a job flow using the tasks. The job flow represents a series of processes obtained by combining a plurality of tasks. The job flow is a unit to execute tasks as one job, i.e., a unit to successively execute a plurality of tasks. A created job flow is managed in the management server 11, and can be executed from the printing apparatus A 16 or printing apparatus B 17.

<Operation Flow>

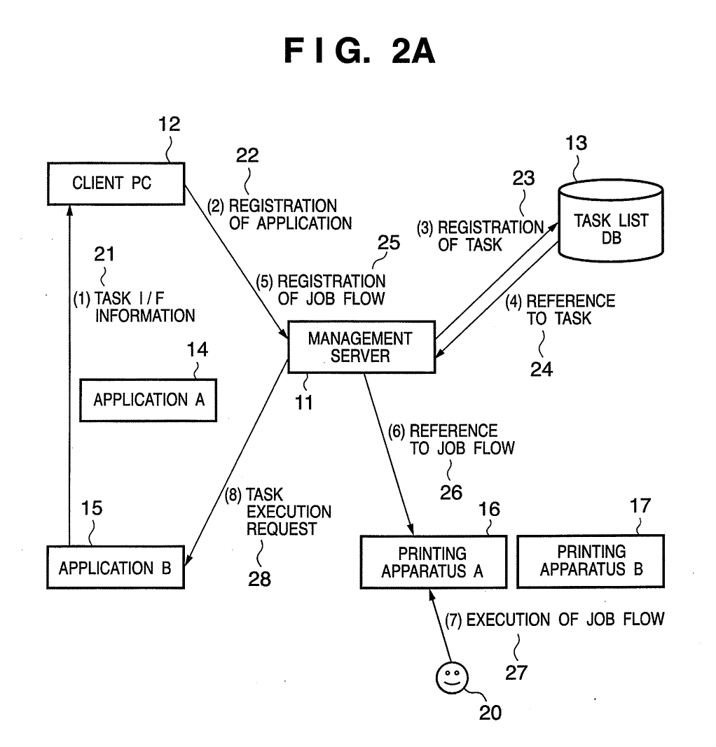

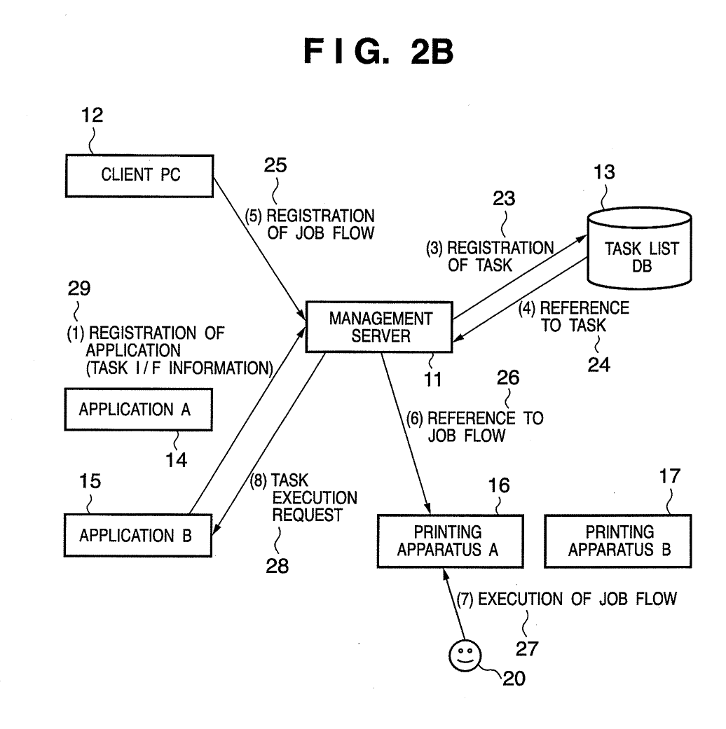

FIGS. 2A and 2B each show an operation flow from addition of a new application (application including a task available for a job flow) up to execution of a job flow by the task cooperation processing system according to the embodiment. FIG. 2A shows a system which registers an application via the client PC 12, and FIG. 2B shows a system which registers an application without the mediacy of the client PC 12.

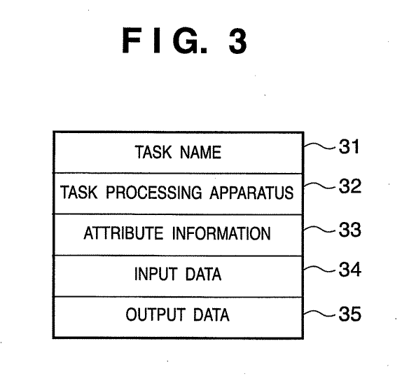

A case (FIG. 2A) where an application is registered via the client PC 12 will be explained on the assumption that the application B 15 is newly added. The client PC 12 acquires task interface (I/F) information of the newly added application B 15 from the application B 15 (21). The task I/F information contains, e.g., the definition of input data necessary for a task, and that of output data obtained by executing the task. The client PC 12 transmits, to the management server 11, application information containing the acquired task I/F information (22), and requests the management server 11 to register the application. Upon reception of the application information and the registration request, the management server 11 registers task information of the application B 15 in the task list DB 13 (23). At this time, the management server 11 generates task definition information (to be described with reference to FIG. 3) on the basis of the task I/F information, and registers it in the task list DB 13. In this way, a task executable by the application B 15 is registered in the task list DB 13.

Upon complication of the registration process, a job flow containing the task of the application B 15 can be created. A job flow is created by the client PC 12. In creating a job flow, the client PC 12 refers to a list of tasks registered in the task list DB 13 via the management server 11 (24), and combines desired tasks to create and register a job flow (25). The registered job flow is managed in the management server 11.

Upon completion of registering the job flow, it can be executed from a printing apparatus managed by the management server 11. For example, the printing apparatus A 16 can refer to a list of job flows managed by the management server 11 (26). A user 20 who wants to execute a job flow operates the printing apparatus A 16 to select a desired job flow from the job flow list and execute the selected job flow (27). Upon reception of the job flow execution request, the management server 11 requests a task processing apparatus capable of executing tasks in the job flow, to execute the tasks (28). As a result, the selected job flow is executed. Note that which of task processing apparatuses is to execute a task in a job flow, the task name, and the like are managed as task definition information in the task list DB 13, details of which will be explained with reference to FIG. 3.

The task cooperation processing system operates as shown in FIG. 2B in a case where an application is registered without mediacy of the client PC 12. The operation flow in FIG. 2B is different from that in FIG. 2A in that the management server 11 acquires task I/F information of a newly added application (application B 15) directly from the application B 15 (29). In FIG. 2B, registration (21) of task I/F information in the client PC 12 from the application B 15, and registration (22) of the application in the management server 11 from the client PC 12 are omitted. The remaining operation flow is the same as that in FIG. 2A.

<Task Definition Information>

FIG. 3 shows task definition information in registering (task registration (23)) task information in the task list DB 13 in the embodiment. The task definition information contains a task name 31, task processing apparatus 32, attribute information 33, input data 34, and output data 35. The task name 31 represents the task name of a task. The task processing apparatus 32 represents a task processing apparatus capable of executing the task. The attribute information 33 is necessary to execute the task.

The attribute information 33 will be explained by exemplifying an application which selects a form and master data to be inserted into the form and outputs the resultant form after form combining. In this application, the form output format includes two patterns: a pattern to output data in the PDF format and a pattern to output data in a form format specific to the application. When the form is to be output, either pattern must be designated. That is, when form output is executed, no task can be executed unless the output format is designated. The attribute information 33 of the form output task represents the output format designated to execute a task. In designation, either the PDF output or the specific format output is designated in the field of the attribute information 33.

The input data 34 is necessary to execute the task. The output data 35 is output by executing the task. A plurality of types of data can be defined for each of the input data 34 and output data 35. Note that the description format of the task definition information is not particularly limited.

<Job Flow Definition Information>

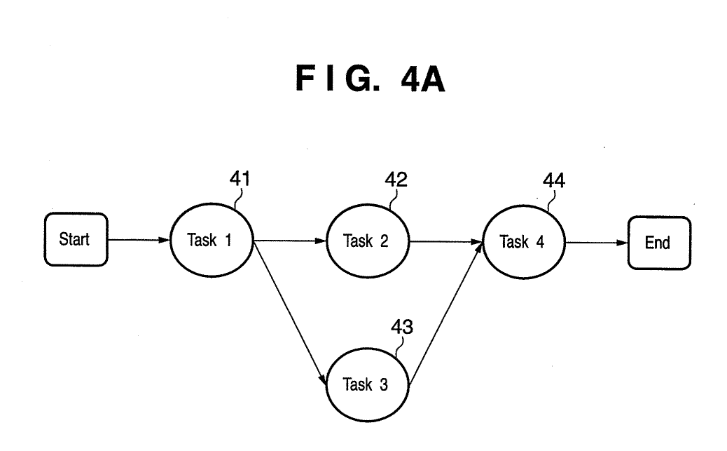

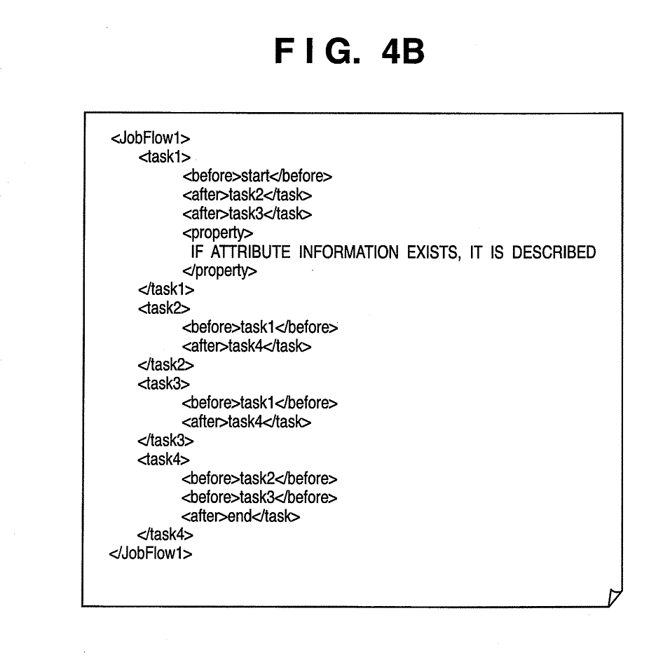

Definition information of a job flow (job flow definition information) that is generated by the client PC 12 and registered in the management server 11 will be explained. FIGS. 4A and 4B are views for explaining the job flow definition information according to the embodiment.

FIG. 4A schematically shows the job flow definition information in order to explain the job flow definition information according to the embodiment. The example of FIG. 4A shows a job flow to execute a task 41 (Task 1), then parallel-process a task 42 (Task 2) and task 43 (Task 3), execute a task 44 (Task 4), and end.

FIG. 4B shows, in the XML format, the job flow definition information illustrated in FIG. 4A. In the embodiment, in order to define the execution order of tasks, a task tag is prepared in XML, the name of a task to be executed before a target task is described in a before tag, and the name of a task to be executed after the target task is described in an after tag. When information (attribute information in FIG. 3) on the attribute of a task is defined in the task definition information, the information is described in a property tag. Such definitions are described by tasks defined in a job flow, completing job flow definition information. Note that the description of the job flow definition information suffices to specify the order of tasks, and is not limited to the XML format.

<Task Icon Display>

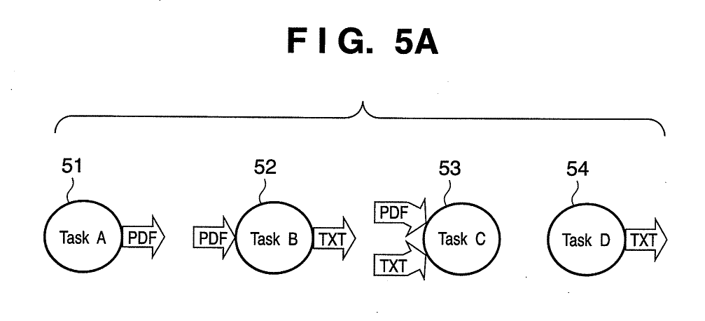

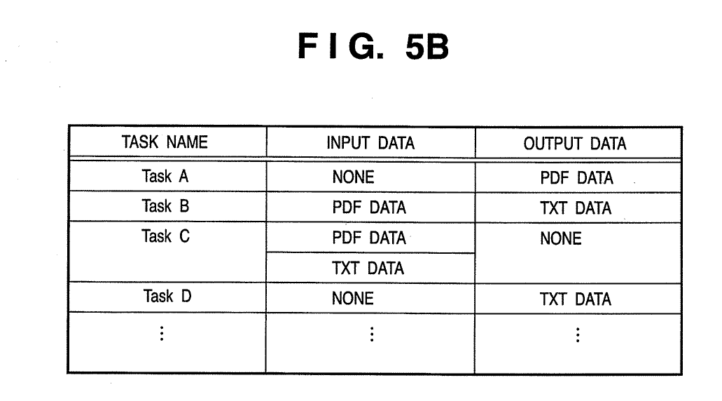

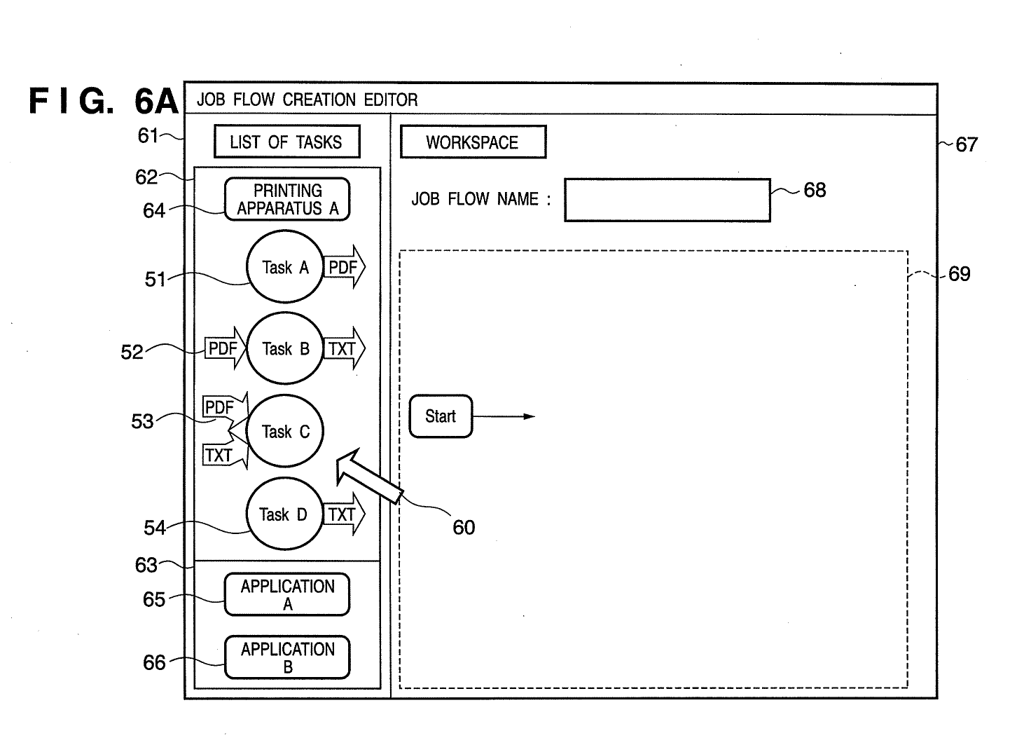

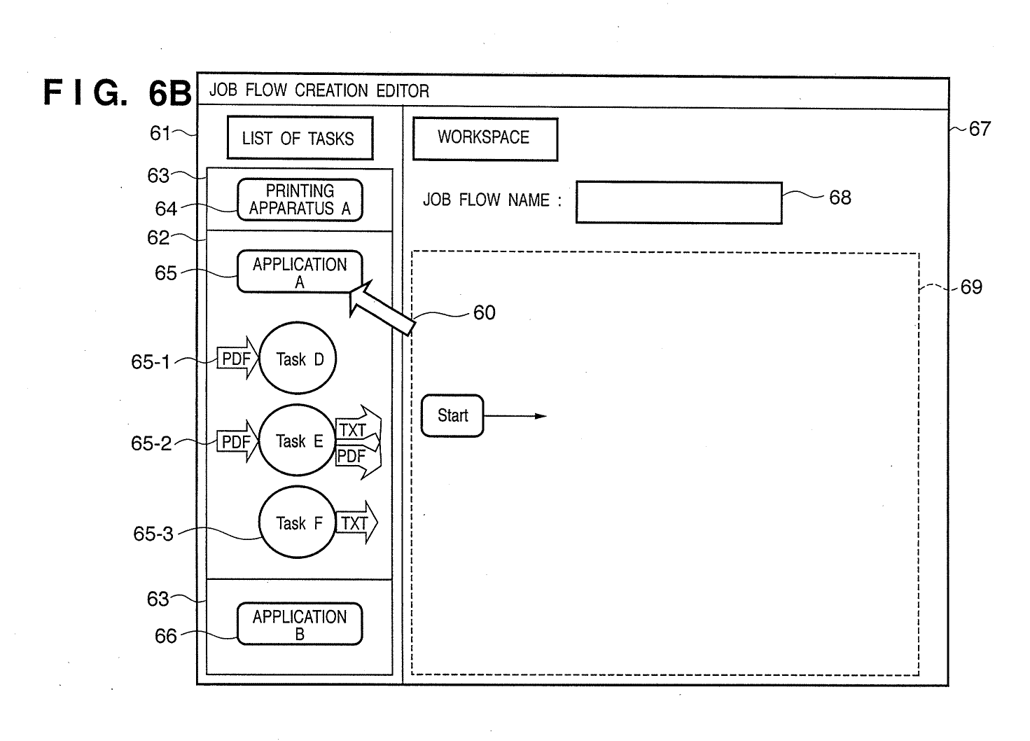

FIG. 5A shows an example of icon display of a task on the basis of task definition information in the embodiment. As described with reference to FIG. 3, the task definition information in the present invention contains input data necessary to execute a task, and output data obtained by executing a task. The icon reflects these pieces of information. In order to easily create a job flow, the task cooperation processing system presents a task as an icon as shown in FIG. 5A in a job flow creation editor. Each task has a meaning as shown in FIG. 5B. For example, for Task A, no input data is defined in task definition information, and “PDF data” is defined as output data. As represented by a Task A icon 51 in FIG. 5A, an arrow is presented together with an output data type (PDF data) on only the output side. For Task B, as shown in FIG. 5B, input data is PDF data, and output data is TXT data. As represented by a Task B icon 52 in FIG. 5A, data types and arrows are presented on the input and output sides. Similarly, for task C, two types of input data are defined, and a Task C icon 53 presents two arrows together with the data types on the input side. In the embodiment, an administrator or authorized user uses the job flow creation editor (to be described with reference to FIGS. 6A and 6B) to create a job flow with icons. An icon representing a task will be called a task icon.

<Job Flow Creation Editor>

FIGS. 6A and 6B are views showing an example of the user interface of the job flow creation editor in the embodiment. The user interface of the job flow creation editor is made up of a task list window 61 and workspace window 67, and operated with a mouse cursor 60.

The task list window 61 is made up of an active subwindow 62 for displaying a list of tasks in a task processing apparatus which is active in operation, and an inactive subwindow 63 for displaying a list of inactive task processing apparatuses. Task processing apparatuses available in the task cooperation processing system are displayed as icons. An icon 64 corresponds to the printing apparatus A 16; an icon 65, to the application A 14; and an icon 66, to the application B 15. That is, FIG. 6A shows that the task processing apparatuses of the printing apparatus A 16, application A 14, and application B 15 are available.

A list of tasks displayed in the active subwindow 62 upon activating the job flow creation editor is a list of tasks of a task processing apparatus set in advance. In the example of FIG. 6A, the printing apparatus A 16 (icon 64) is set as a default. Also in the example of FIG. 6A, the task icons 51 to 54 are displayed in the active subwindow 62 to present that there are four tasks Task A, Task B, Task C, and Task D in the printing apparatus A 16.

The workspace window 67 is made up of a text field 68 for inputting the name of a created job flow, and a job flow creation window 69 for laying out tasks.

FIG. 6B shows the job flow creation editor after the icon 65 of the application A 14 is clicked in creating a job flow. A list of tasks of the selected application A 14 (icon 65) is displayed in the active subwindow 62. A list of tasks of the printing apparatus A 16 which is active upon activation is displayed at once as the icon 64 of the printing apparatus A in the inactive subwindow 63. Note that task icons 65-1 to 65-3 represent tasks present in the application A 14.

The operation of the task cooperation processing system with the above configuration according to the embodiment will be explained with concrete examples.

### EXAMPLE 1

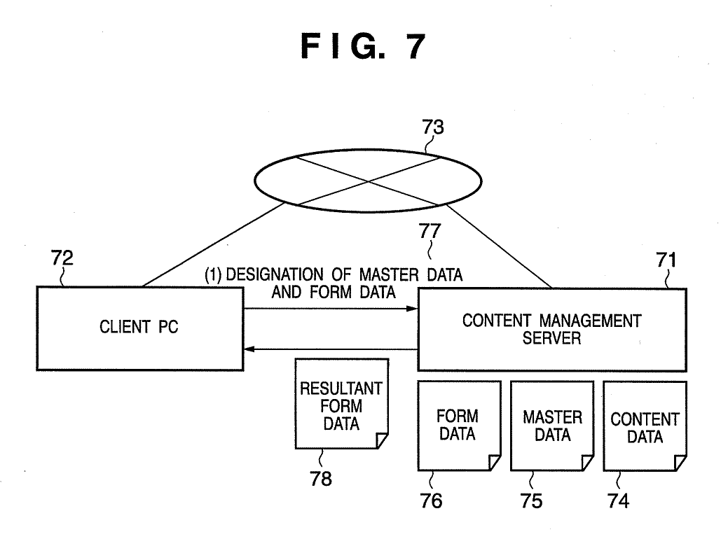

FIG. 7 is a view showing an outline of the task cooperation processing system in example 1. A client PC 72 corresponds to the client PC 12 in FIG. 1. In example 1, cooperative applications are formed from a content management server 71 and the client PC 72, which are connected by a network 73. For example, in FIG. 7, applications concerning forms run in the client PC 72 and content management server 71, respectively, and the applications in the server and client cooperate with each other to form a task. Note that the client PC 72 or content management server 71 may function as the management server 11.

The content management server 71 manages content data 74, master data 75, and form data 76. The content data 74 is prepared by registering image data or PDF catalog data. The master data 75 is prepared by registering basic information of merchandise or the like as text data. The form data 76 is prepared by registering a form template serving as a format for creating form data or the like. The content management server 71 receives, as an input, designation (77) of master data and form data from the client PC 72. The content management server 71 creates resultant form data from the master data and form data, and sends back the resultant form data as an output result (78) to the client PC 72. The job flow which is generated and executed in example 1 can easily create various forms desired by the client.

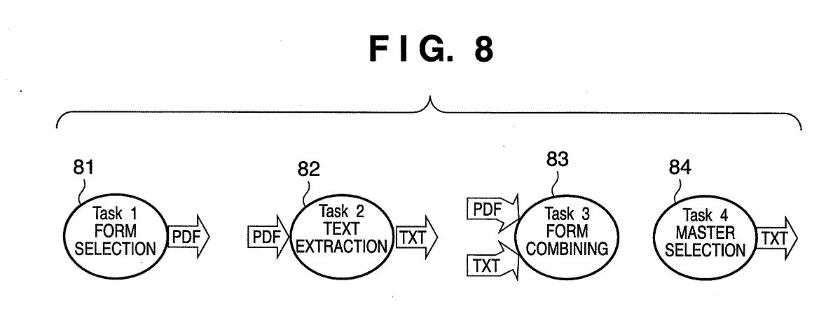

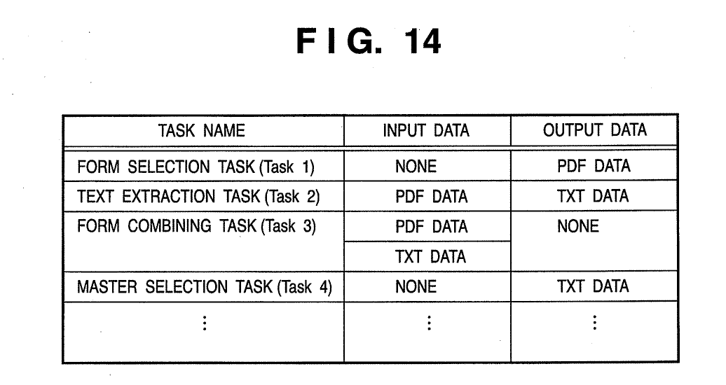

FIG. 8 is a view showing a display example of the icons of some of tasks contained in cooperative applications in example 1. FIG. 8 illustrates four tasks, and input and output data of each task are shown in FIG. 14. A task corresponding to a task icon nn will be referred to as a task (nn). For example, a form selection task (Task 1) is to select form data, and a task icon 81 corresponds to this task. As shown in FIG. 14, the form selection task (81) has 0 input data and one output data. Hence, the task icon 81 presents only output data. A text extraction task (Task 2) is to extract a text from PDF catalog data, and a task icon 82 corresponds to this task. The text extraction task (82) has one input data and one output data, and the task icon 82 specifies this state. Similarly, a form combining task (Task 3) is to combine master data and form data designated by the client into resultant form data. A task icon 83 corresponds to this task. A master selection task (Task 4) is to select master data, and a task icon 84 represents this task.

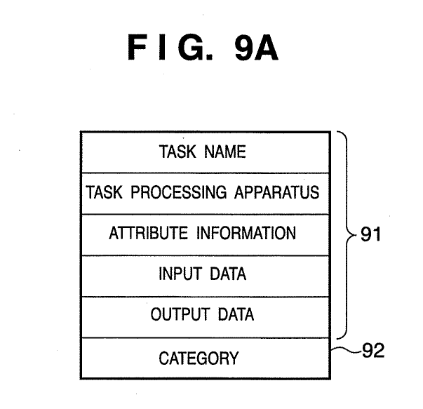

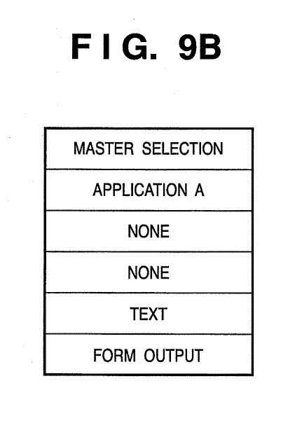

FIGS. 9A and 9B show task definition information for categorizing tasks. FIG. 9A shows task definition information of cooperative applications in the task cooperation processing system. Depending on a cooperative application, category information 92 can be set as additional information of task definition information 91 described with reference to FIG. 3. In this case, for example, a category tag is set in the XML description shown in FIG. 4B to describe a category name. FIG. 9B shows task definition information of the master selection task (84). FIG. 9B represents that the master selection task (84) belongs to the “form output” category of application A (cooperative application in example 1).

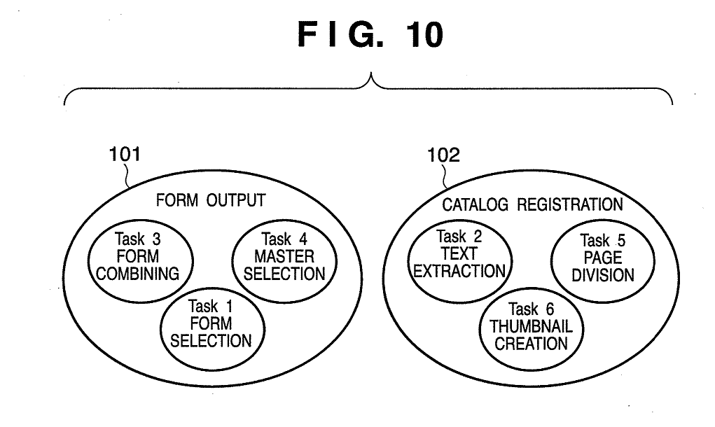

FIG. 10 shows an example of categorizing tasks shown in FIG. 8 and the like by the task definition information in FIGS. 9A and 9B. Tasks available in example 1 can be categorized into a form output category 101 and catalog registration category 102. The form combining task (83), form selection task (81), and master selection task (84) are classified into the form output category 101. The text extraction task (82), thumbnail creation task, and page division task are classified into the catalog registration category 102.

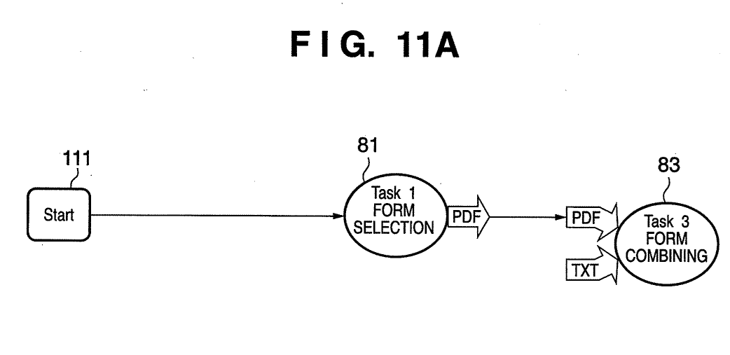

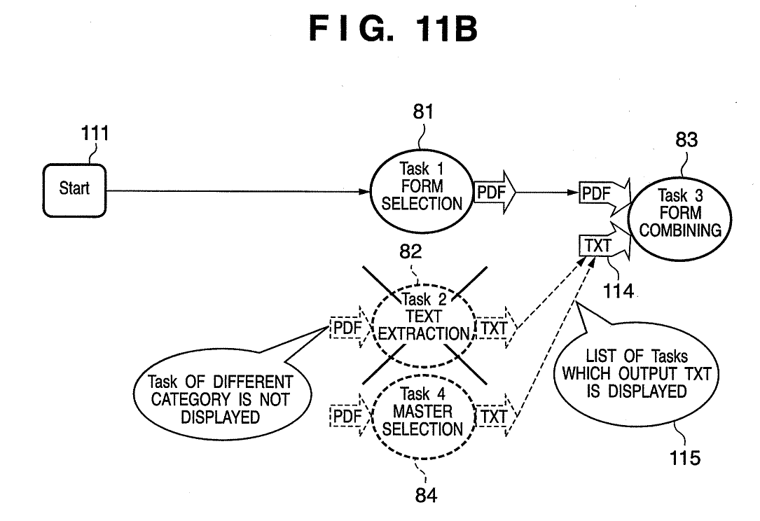

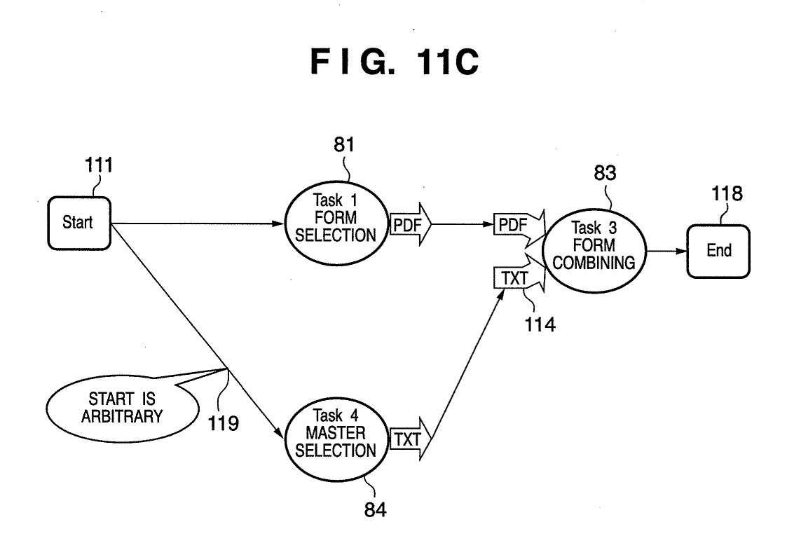

FIGS. 11A to 11C show job flow creation procedures in example 1 using the above-described job flow creation editor. In example 1, the applications shown in FIG. 7 are used to create a job flow which defines a flow up to output of resultant form data. FIGS. 11A to 11C show an example of an operation in the job flow creation window 69 (FIGS. 6A and 6B) of the job flow creation editor.

The job flow creator starts creating a job flow, and lays out task icons, as shown in FIG. 11A. The task icons are laid out by dragging and dropping task icons displayed in the active subwindow 62. In the example of FIG. 11A, the job flow starts from a Start icon 111, and the task icon 81 corresponding to the form selection task and then the task icon 83 corresponding to the form combining task are laid out.

FIG. 11B shows a job flow creation procedure including merge of parallel processes. The task icon 83 represents that two input data are necessary. When the task icon 83 is laid out, as shown in FIG. 11A, a corresponding form combining task requires two input data: PDF data and TXT data. When the task icon 83 is laid out, the two input data are not prepared, and no task can be laid out following the task icon 83 (form combining task).

For this reason, when the icon of a task requiring a plurality of inputs is laid out in the job flow creation window 69 (FIGS. 6A and 6B), task candidates having, as output data, data necessary as inputs for the task are displayed (115: in practice, no “balloon” 115 is displayed). In the example of FIGS. 11A and 11B, task candidates having, as output data, data 114 necessary as inputs for the form combining task are displayed when the task icon 83 is laid out in the job flow creation window 69. Note that task icons displayed as candidates in example 1 are icons representing tasks which have output data of the same data type as that of input data necessary for the form combining task (83) and belong to the same category as that of the form combining task (83).

By outputting tasks of the same category as candidates, it can be avoided to lay out a task which has an output of the same data type as that of an input but cannot actually establish a job flow. When output data require cooperation of a plurality of tasks, processed data are only transferred without limiting a subsequent task. To the contrary, when a plurality of input data are required, like the above-mentioned form combining task, a limitation must be posed. That is, when a task at the following stage is connected to the output side of a target task, it suffices that the output data type of the target task matches the input data type of the following task. However, when a task is connected to the input side of the target task, matching of the category must also be considered. In this example, this limitation is implemented by categorizing and managing tasks available to create a job flow, including a task requiring a plurality of inputs.

For example, output data of the text extraction task is TXT data, and its data type is the same as that of input data of the form combining task. However, the text extraction task belongs to a category different from that of the form combining task, and cannot be defined in the job flow. Hence, the task icon 82 corresponding to the text extraction task cannot be defined in the job flow, and is not displayed as a candidate, as shown in FIG. 11B. Output data of the master selection task (84) is of the same data type (TXT data) as that of input data of the form combining task, and the master selection task is managed in the same category as that of the form combining task. Thus, the task icon 84 corresponding to the master selection task is displayed as a candidate, as shown in FIG. 11B. Display of a task icon corresponding to a candidate task is not limited to a broken line as shown in FIG. 11B. For example, a task icon can be displayed in any fashion, such as a predetermined color or blinking, as far as the user can recognize that a displayed task icon is a candidate task.

When a list of candidate tasks is displayed in this fashion, the job flow creator can select, from the candidate task list (containing only the task icon 84 in FIG. 11B), a desired task necessary to execute the form combining task (task icon 83). A task icon selected from the candidate task list is laid out as a task (task at the previous stage of the form combining task) preceding to the form combining task represented by the task icon 83. For example, if the task icon 84 (master selection task) is selected, the master selection task is laid out at the previous stage of the form combining task so as to execute this task parallel to the form selection task, generating a job flow as shown in FIG. 11C.

FIG. 11C shows the result of creating a job flow containing merge of parallel processes. In the job flow of FIG. 11C, an End icon 118 is connected after the task icon 83. When the form combining task is executed after form selection and master selection, processes complying with the job flow end.

When a task selected from the candidate task list shown in FIG. 11B further requires input data, candidate tasks connectable to the selected task are displayed by the same procedures as those described above. On the contrary, when the selected task does not require any input data, the execution start point of the selected task can be arbitrarily set. In the example of FIG. 11C, the selected master selection task (task icon 84) does not require any input data. In FIG. 11C, the execution start point of the master selection task represented by the task icon 84 is set at the start point of the job flow (119: in practice, no “balloon” 119 is displayed). Setting of the execution start point of a task may be variously modified such that the execution start point is set at the start point of the job flow as a default and arbitrarily set by a user operation instruction.

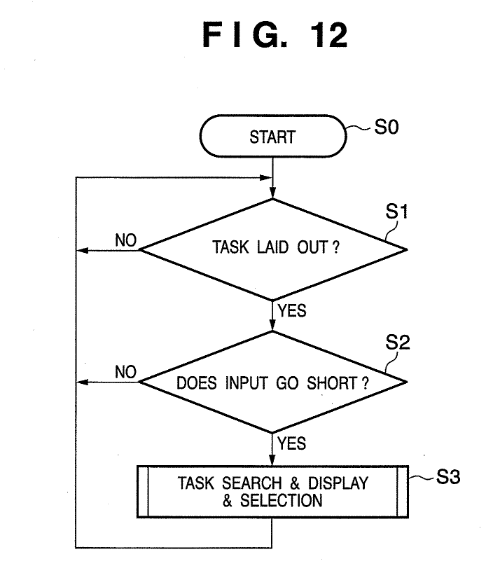

FIG. 12 is a flowchart showing the whole process of the job flow creation editor in the embodiment.

When the job flow creation editor is activated to start processes, it is checked in step S1 whether a task is laid out in the job flow creation window 69 (FIGS. 6A and 6B). If the task is laid out, the flow advances from step S1 to step S2 to check whether input data of the laid-out task go short. If output data of a task at the previous stage do not satisfy all input data of the laid-out task, it is determined that the input data go short. If the input data do not go short, the flow returns to step S1; if the input data go short, advances to step S3 to display candidate tasks as described above in FIG. 11B and prompt the user to select a task. After that, the flow returns to step S1 to repeat the above process. The process shown in FIG. 12 is repeated until the end of creating the job flow is detected (in the embodiment, until layout of an End icon is detected). If the End icon is laid out, it is determined that creation of the job flow ends, and the process ends.

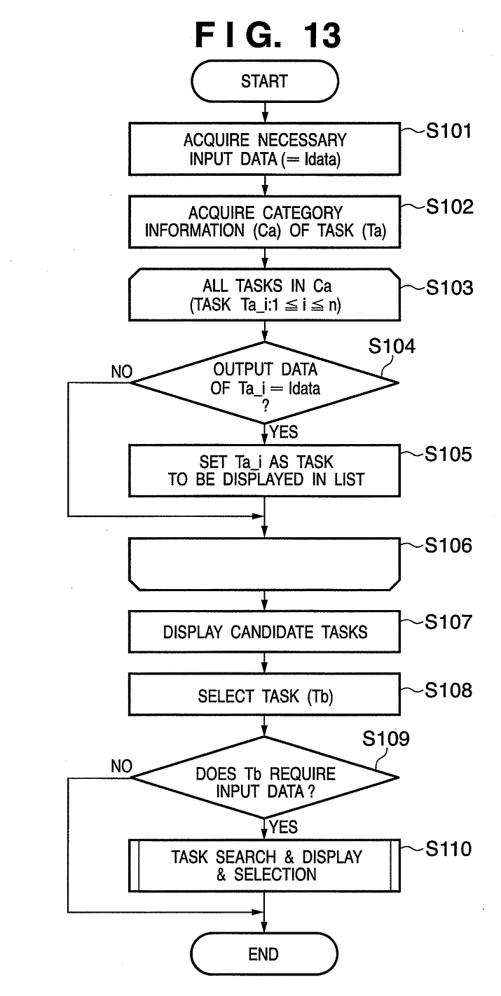

FIG. 13 is a flowchart showing a task search & display & selection process (step S3 in FIG. 12) in the embodiment.

In step S101, the type of input data (short input data) necessary for a target task is stored in Idata. In step S102, category information (=Ca) of the target task (=Ta) is acquired. In steps S103 to S106, out of all tasks belonging to the category Ca, tasks whose output data type coincide with the input data type (Idata) of the target task are selected as list display targets. More specifically, in step S104, it is determined whether the output data type of the ith task Ta_i coincides with Idata. If the output data type of the ith task Ta_i coincides with Idata, the task Ta_i is set as a list display target in step S105. The processes in steps S104 and S105 are performed for all tasks (i=1 to n: n is the number of all tasks belonging to the category Ca) belonging to the category Ca (steps S103 and S106). Accordingly, candidate tasks are selected by referring to task definition information registered in the task list DB 13.

After the processes in steps S103 to S106 end, the flow advances to step S107 to display a list of tasks set as candidate tasks. If the job flow creator selects a task from the displayed ones, the flow advances from step S108 to step S109. Note that Tb represents the selected task. In step S109, it is checked whether the selected task Tb requires input data. If the selected task Tb does not require input data, the process ends; if the selected task Tb requires input data, advances to step S110 to recursively perform the “task search & display & selection” process for the selected task Tb.

The job flow creation process shown in FIGS. 11A to 11C will be explained with reference to the flowcharts in FIGS. 12 and 13.

When the job flow editor is activated, the process shown in FIG. 12 starts. The user lays out the Start icon 111, and then the task icon 81 of the form selection task. After the task icon 81 of the form selection task is laid out, the flow advances from step S1 to step S2 to check whether the laid-out form selection task requires a plurality of input data, i.e., necessary input data go short. Since the form selection task does not require any input data (no input data goes short), as described above, the process returns from step S2 to step S1 to wait for layout of the next task. If the user lays out the task icon 83 corresponding to the form combining task, the process advances again from step S1 to step S2 to check whether input data of the form combining task (83) go short. The form combining task requires PDF data and TXT data as input data. Hence, inputs go short by only PDF data which is output data of the form selection task, so the process advances from step S2 to step S3.

In step S3, a candidate task is displayed (task icon 84 in FIG. 11B is displayed) to prompt the user to select the task.

More specifically, the type of input data which is short for the form combining task (83), and the category to which the form combining task (83) belongs are acquired to search for a task which has output data that matches the acquired input data type, and which belongs to the acquired category (steps S101 to S106). The detected task is displayed as a candidate task, as shown in FIG. 11B (step S107). In the example of FIG. 11B, the task icon 84 is displayed as a candidate task. If the task icon 84 is selected, the master selection task does not require any input data. Thus, the process in step S3 ends in step S109, and the flow returns to step S1.

As described above, in example 1, when input data go short, a connectable candidate task is automatically selected and presented. The user can easily create a complicated job flow containing parallel processes. In example 1, since tasks are categorized and registered, a task connectable at the previous stage of a task in which data inputs go short can be extracted using a match between the types of output data and input data and a match of the category. An appropriate task can be presented to further improve the operability of job flow generation.

### EXAMPLE 2

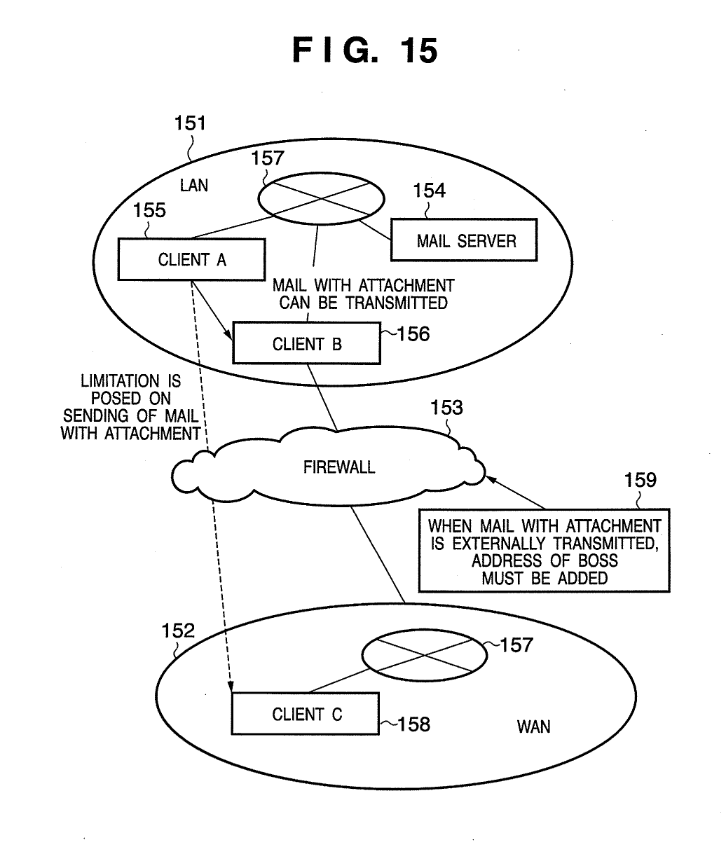

Example 2 will be explained. In example 1, the category of a task is determined by task definition information. In example 2, categories are managed hierarchically, and a candidate task can be acquired from the same category as that of a destination task and its upper category. FIG. 15 shows an outline of cooperative applications in example 2.

Cooperative applications in example 2 are connected to a LAN 151 and WAN 152, and the LAN 151 and WAN 152 are connected to each other via a firewall 153. In the LAN 151, a mail server 154, client A 155, and client B 156 exist, which are connected by a network 157. In the WAN 152, a client C 158 exists, which is connected by the network 157. Note that the number of mail servers and that of clients in the LAN 151, and the number of clients in the WAN 152 are not particularly limited. For descriptive convenience, example 2 will be explained using this configuration.

Cooperative applications in example 2 build a system in which only mail that satisfies a predetermined condition can be sent upon sending mail with an attachment (mail with an attachment file) from the LAN environment (inside the office) to the WAN environment (outside the office). A mail sending application in example 2 has a mechanism (159) of, when the sender transmits mail with an attachment outside the office, inhibiting sending of mail to the WAN environment (outside the office) unless the address of his boss is designated at the address (To or Cc). This is one of methods frequently used to protect in-house confidential information.

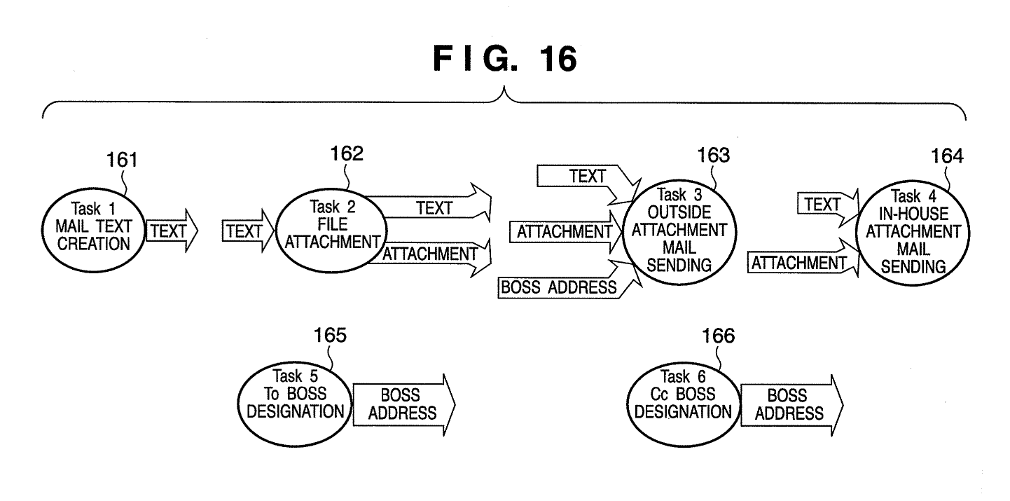

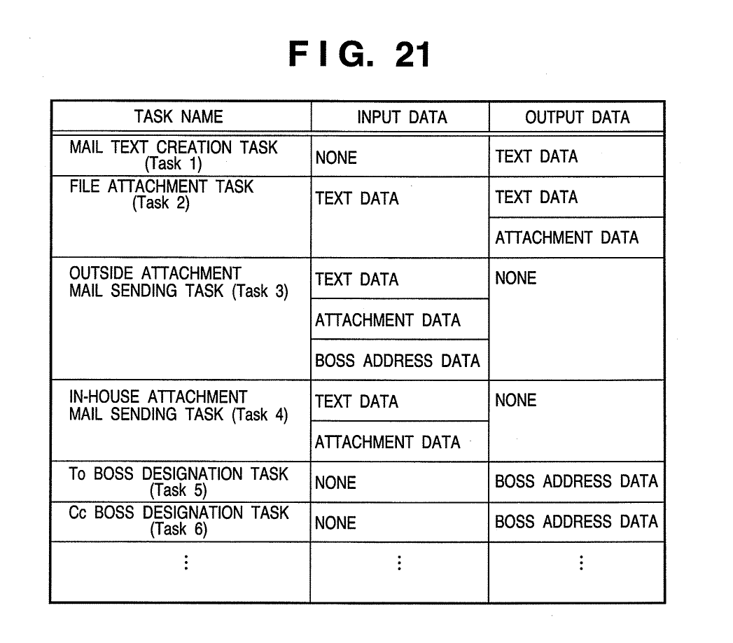

FIG. 16 shows a display example of task icons corresponding to some of tasks in cooperative applications in example 2. As shown in FIG. 21, tasks in cooperative applications in example 2 are a mail text creation task, file attachment task, outside attachment mail sending task, in-house attachment mail sending task, To boss designation task, and Cc boss designation task. The input and output data of these tasks are shown in FIG. 21.

The mail text creation task is to create a mail text, and a task icon 161 corresponds to this task. The file attachment task is to attach a file to a mail text, and a task icon 162 corresponds to this task. The outside attachment mail sending task is to send mail with an attachment outside the office, and a task icon 163 corresponds to this task. The in-house attachment mail sending task is to send mail with an attachment inside the office, and a task icon 164 corresponds to this task. The To boss designation task is to designate the address of the boss, and a task icon 165 corresponds to this task. The Cc boss designation task is to designate the address of the boss as Cc, and a task icon 166 corresponds to this task.

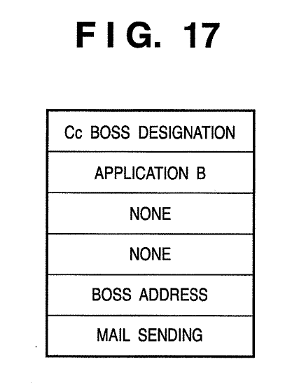

FIG. 17 is a view showing an example of task information in example 2. FIG. 17 shows task definition information of the Cc boss designation task (166) serving as a task of the application. According to the definition information in FIG. 17, the Cc boss designation task (166) belongs to the mail sending category of application B (corresponding to a cooperative application in example 2).

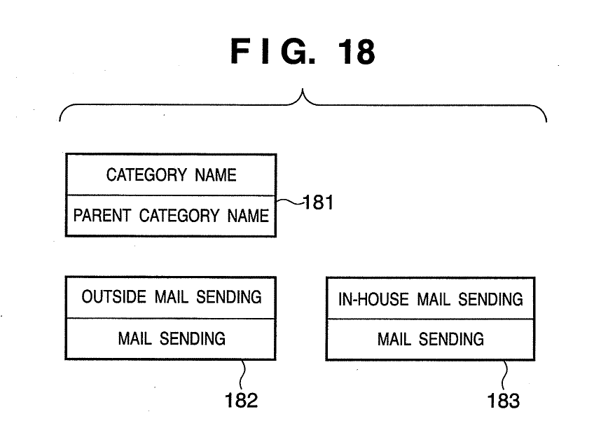

FIG. 18 is a view for explaining hierarchical management of categories. Depending on a cooperative application, there are many tasks each belonging to a plurality of categories. In example 2, tasks each belonging to a plurality of categories are collected and managed in a parent category, and the difference tasks are managed in a child category. With this setting, categories can be managed hierarchically. For example, “category name” and “parent category name” representing the parent of a category are defined, as represented by 181 in FIG. 18. This exhibits that a task belonging to a parent category represented by “parent category name” belongs to a target category. In example 2, as represented by 182 and 183, the outside mail sending category and in-house mail sending category have a mail sending category as their parent category. The hierarchical category management information is managed by the management server 11 (FIG. 1). Note that any one of the clients A to C and mail server 154 may function as the management server 11.

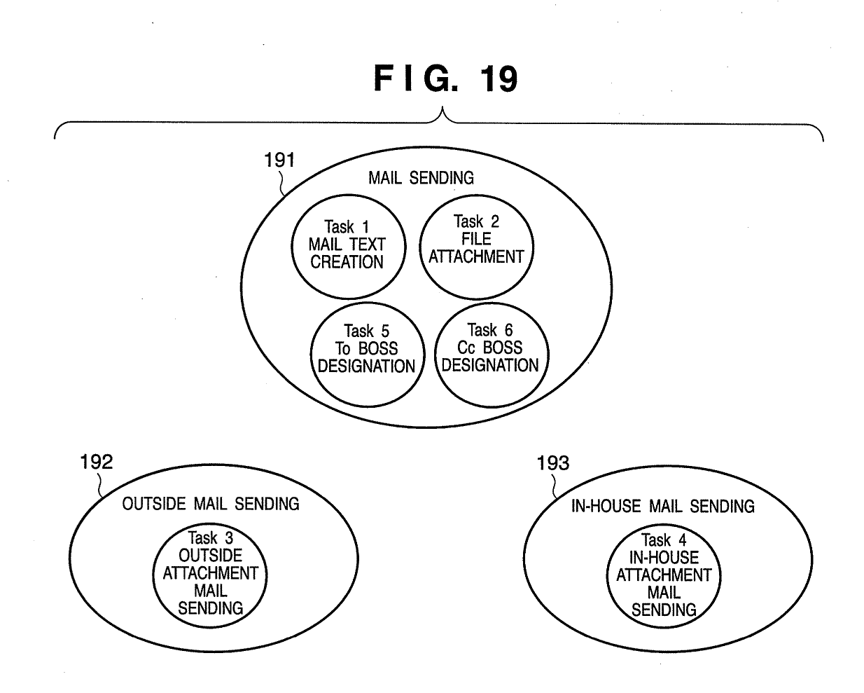

FIG. 19 shows an example of categorizing tasks on the basis of the task definition information in FIG. 17, the tasks shown in FIG. 21, and the hierarchical category management information shown in FIG. 18. Based on the hierarchical category management information shown in FIG. 18, tasks can be categorized into a mail sending category 191, outside mail sending category 192, and in-house mail sending category 193. The outside mail sending category 192 and in-house mail sending category 193 have the mail sending category 191 as a parent category. The mail text creation task (161), file attachment task (162), To boss designation task (165), and Cc boss designation task (166) are classified into the mail sending category 191 serving as the parent category of the outside mail sending category 192 and in-house mail sending category 193. The outside attachment mail sending task (163) is classified into the outside mail sending category 192, whereas the in-house attachment mail sending task (164) is classified into the in-house mail sending category 193.

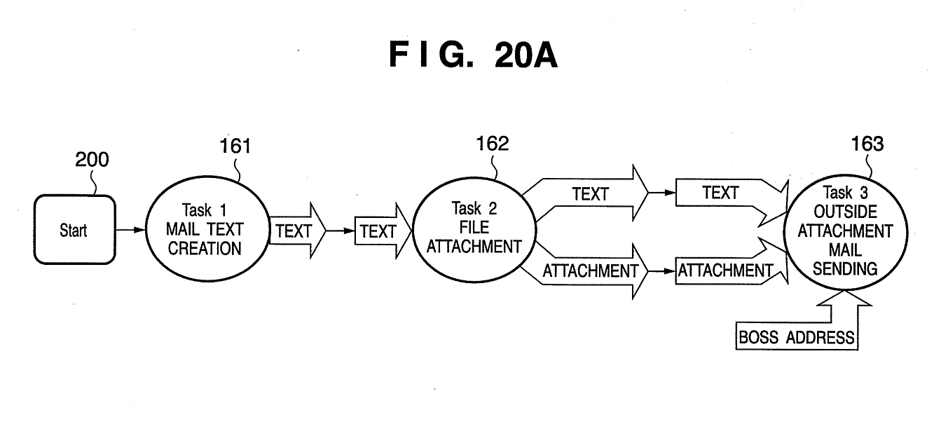

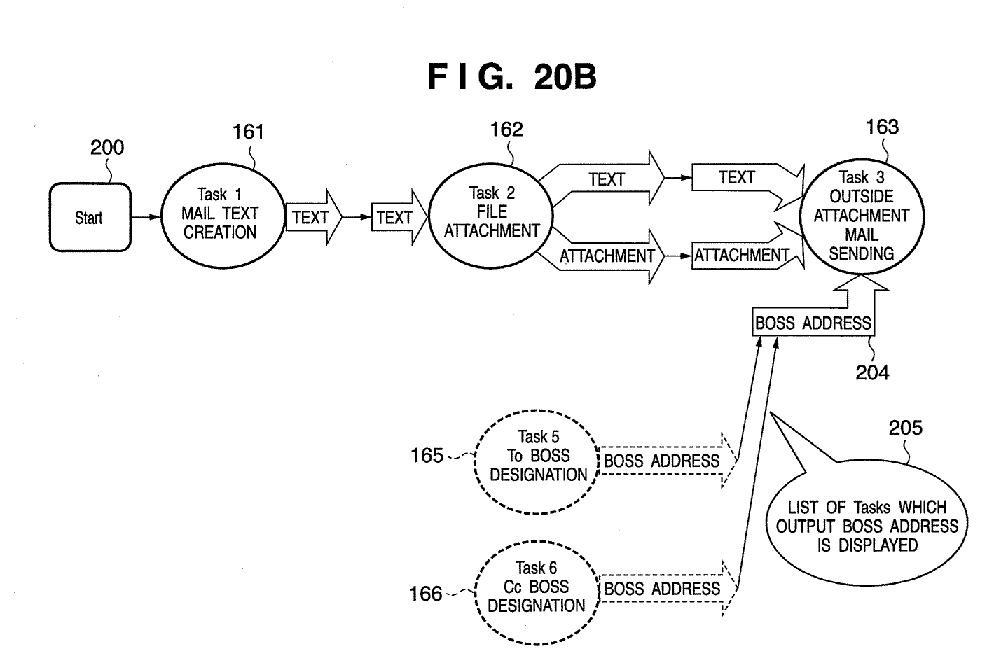

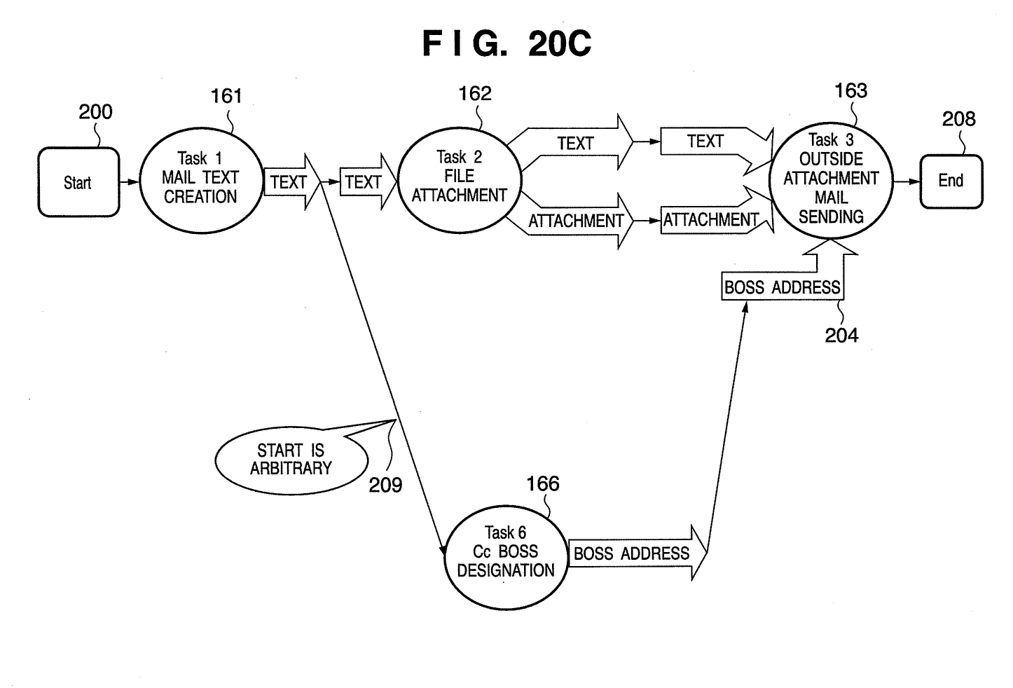

FIGS. 20A to 20C show job flow creation procedures in example 2. FIGS. 20A to 20C show creation procedures to define, as a job flow, a flow up to sending of mail with an attachment outside the office by using the application shown in FIG. 15. The job flow is created in the job flow creation window 69 (FIGS. 6A and 6B) of the job flow creation editor.

In FIG. 20A, the mail text creation task (161), file attachment task (162), and outside attachment mail sending task (163) are coupled. The job flow creator starts creating a job flow using the above-described job flow creation editor. In the example of FIG. 20A, the job flow starts from a Start icon 200, and the task icon 161 corresponding to the mail text creation task, the task icon 162 corresponding to the file attachment task, and the task icon 163 corresponding to the outside attachment mail sending task are laid out.

The outside attachment mail sending task (163) requires three input data: text data, attachment data, and boss address data. When the task icon 163 is laid out in FIG. 20A, input data of the outside attachment mail sending task are short. For this reason, no task can be laid out following the outside attachment mail sending task (163).

As described in example 1, if input data of a task laid out in the job flow creation window 69 (FIGS. 6A and 6B) go short, a candidate task is displayed upon laying out the task. That is, a list of tasks which have, as output data, data 204 necessary as an input for the laid-out task and belong to the same category as that of the laid-out task is displayed (FIG. 20B). In example 2, categories are managed hierarchically, and tasks in the parent category are also targeted as candidate tasks. As described with reference to FIG. 19, the outside attachment mail sending task (163) belongs to the outside mail sending category 192, the outside mail sending category 192 has the mail sending category 191 as a parent, and thus tasks belonging to the mail sending category 191 are also selected as candidate tasks. Resultantly, as shown in FIG. 20B, the task icons 165 and 166 corresponding to the To boss designation task and Cc boss designation task are displayed as candidates (205: in practice, no “balloon” 205 is displayed). In the example of FIG. 20B, the task icons 165 and 166 of the To boss designation task and Cc boss designation task are displayed as candidate tasks when the task icon 163 of the outside attachment mail sending task is laid out in the job flow creation window 69 (FIGS. 6A and 6B).

In order to execute the outside attachment mail sending task corresponding to the task icon 163 shown in FIG. 20B, the job flow creator can select a desired task from the displayed candidate task list. The selected candidate task is laid out and connected to the outside attachment mail sending task. FIG. 20C shows a job flow display state in which the task icon 166 of the Cc boss designation task is selected in the example of FIG. 20B. In the job flow of FIG. 20C, an End icon 208 is laid out following the outside attachment mail sending task, and the job flow ends when the outside attachment mail sending task (163) is executed. Note that the execution start point of the Cc boss designation task (166) can be arbitrarily set. In FIG. 20C, it is set to execute the Cc boss designation task after executing the mail text creation task (209: in practice, no “balloon” 209 is displayed).

Process procedures in the job flow creation process shown in FIGS. 20A to 20C will be explained with reference to the flowcharts in FIGS. 12 and 13.

When the job flow editor is activated, the process in FIG. 12 starts. The Start icon 200 is laid out, and the task icon 161 of the mail text creation task is laid out. Then, the flow advances from step S1 to step S2. In step S2, it is checked whether input data of the mail text creation task corresponding to the laid-out task icon 161 go short. In example 2, the mail text creation task requires “no” input data, and the flow returns to step S1 to wait for layout of the next task. The task icon 162 of the file attachment task is laid out next to the task icon 161 of the mail text creation task. After the task icon 162 of the file attachment task is laid out, the flow advances from step S1 to step S2 to check whether input data of the file attachment task (162) go short, similar to the process after the mail text creation task is laid out. Input data of the file attachment task is satisfied by output data of the mail text creation task (161) at the previous stage, and the process returns to step S1.

If the task icon 163 of the outside attachment mail sending task is laid out, the flow advances from step S1 to step S2 to check whether input data go short. The outside attachment mail sending task (163) requires text data, attachment data, and boss address data as input data. In the connection state of FIG. 20A, text data and attachment data can be obtained from the file attachment task, but no boss address data can be acquired. That is, output data of the file attachment task cannot provide all input data of the outside attachment mail sending task (163), so the process advances to step S3. In step S3, the above-described process shown in FIG. 13 is executed.

In example 2, unlike example 1, hierarchical category management information as shown in FIG. 18 is referred to, and when the category to which a target task belongs has a parent category, tasks belonging to the parent category are also targeted as candidate tasks. That is, tasks subjected to the processes in steps S103 to S106 belong to the category to which the target task belongs and the parent category. In steps S103 to S106, tasks having boss address data as output data are extracted from tasks belonging to the same category (outside mail sending category 192) as that of the outside attachment mail sending task (163) and tasks belonging to the parent category (mail sending category 191). In step S107, the extracted tasks are displayed as candidate tasks, as shown in FIG. 20B.

If the user selects one of the candidate tasks, the output of the selected task (in FIG. 20C, the Cc boss designation task (166)) is connected to the input of the outside attachment mail sending task. As a result, the shortage of input data of the outside attachment mail sending task is canceled.

Thereafter, as shown in FIG. 20C, the End icon 208 is laid out to complete generation of the job flow.

As described above, in example 2, categories are managed hierarchically, and candidate tasks are acquired from a target category and its upper category. With this setting, categories can be managed more flexibly.

### EXAMPLE 3

Example 3 will be explained. In example 3, a case where one task belongs to a plurality of categories and a case where a task selected by the task search & display & selection process further requires input data will be described.

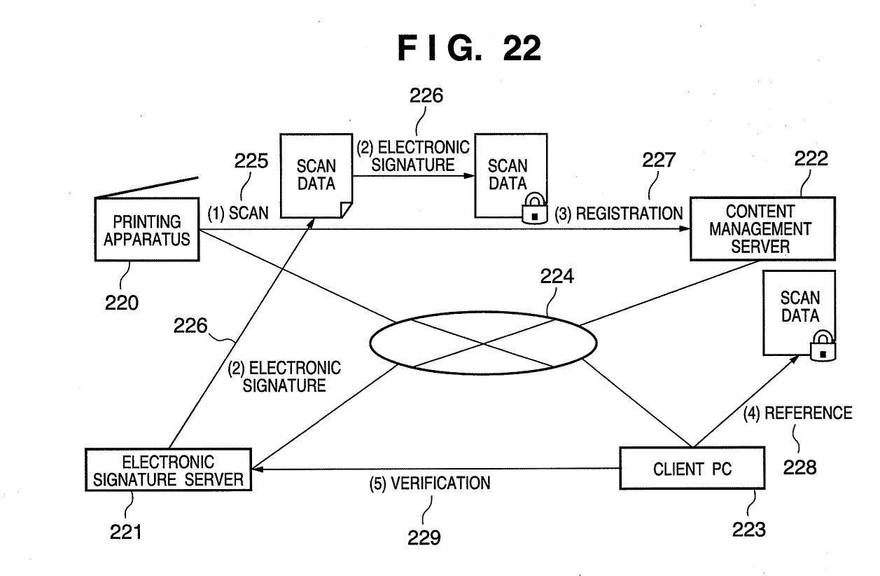

FIG. 22 shows an outline of cooperative applications in example 3. Cooperative applications in example 3 are built by a printing apparatus 220, electronic signature server 221, content management server 222, and client PC 223, which are connected by a network 224.

Cooperative applications in example 3 are electronic signature-compatible applications. By using the electronic signature server 221, the application attaches (226) an electronic signature to data scanned (225) by the printing apparatus 220. The application registers the scan data having the electronic signature as contents in the content management server 222 (227). A user capable of operating the client PC 223 can refer (228) to the contents (data scanned by the printing apparatus) with the electronic signature that is registered in the content management server 222. In order to verify the authenticity of the contents with the electronic signature, as needed, verification 229 can also be requested of the electronic signature server. Note that the content management server 222 or electronic signature server 221 may function as the management server 11.

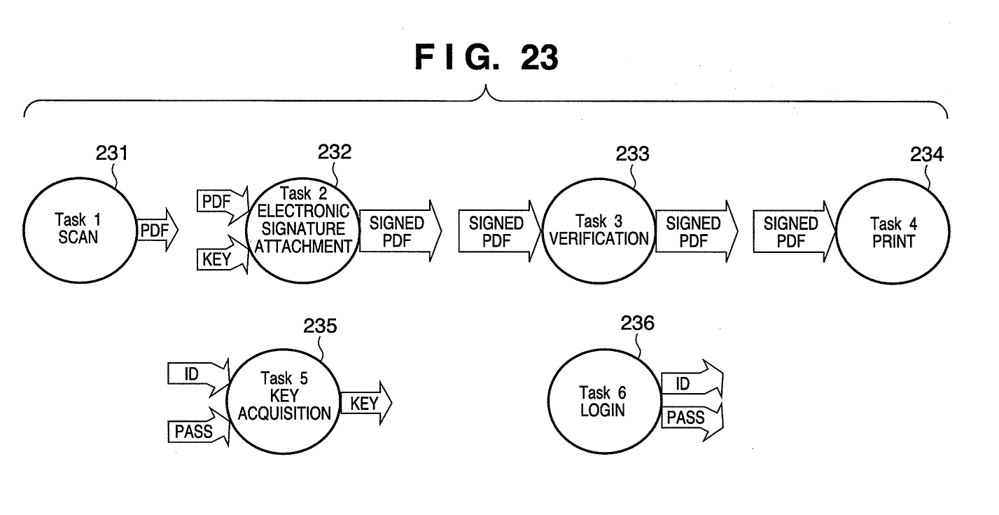

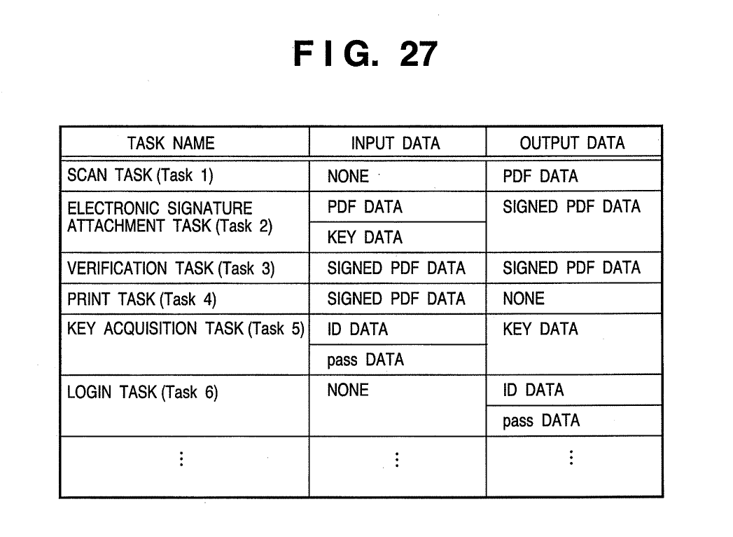

FIG. 23 shows a display example of the icons of some of tasks in cooperative applications in example 3. As shown in FIG. 27, tasks in cooperative applications in example 3 are a scan task, electronic signature attachment task, verification task, print task, key acquisition task, and login task. The scan task (231) is to scan a paper document. The electronic signature attachment task (232) is to attach an electronic signature. The verification task (233) is to verify signed data. The print task (234) is to print data. The key acquisition task (235) is to acquire a key for attaching an electronic signature. The login task (236) is to authenticate a user. The input and output data of these tasks are shown in FIG. 27. In FIG. 23, the task icons 231 to 236 correspond to the scan task, electronic signature attachment task, verification task, print task, key acquisition task, and login task.

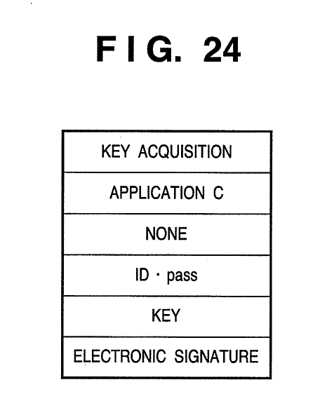

FIG. 24 shows task definition information of the key acquisition task (235) serving as a task of the application in example 3. FIG. 24 shows that the key acquisition task belongs to the “electronic signature” category of application C (corresponding to a cooperative application in example 3). FIG. 24 also shows that ID data and pass data are necessary as input data, and key data is output as output data.

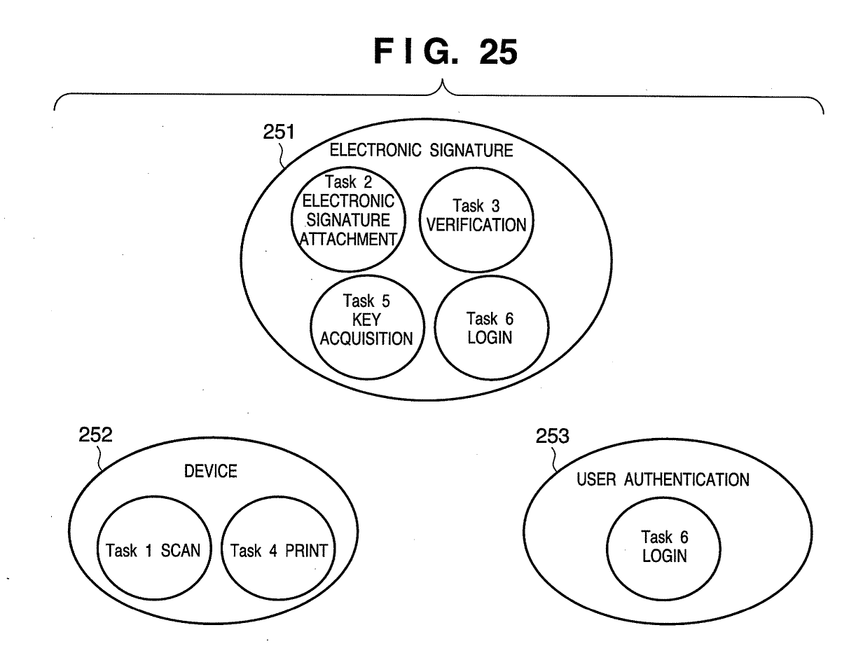

FIG. 25 shows an example of categorizing tasks on the basis of the task definition information in FIG. 24 and the tasks shown in FIG. 23. In example 3, tasks are categorized into an electronic signature category 251, device category 252, and user authentication category 253. The electronic signature attachment task (232), verification task (233), key acquisition task (235), and login task (236) are classified into the electronic signature category 251. The scan task (231) and print task (234) are classified into the device category 252, and the login task (236) is classified into the user authentication category 253.

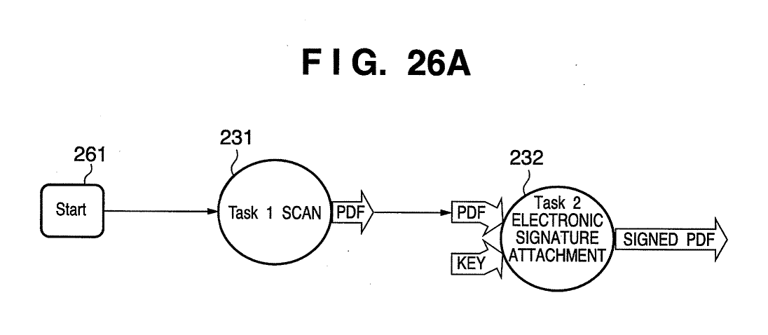

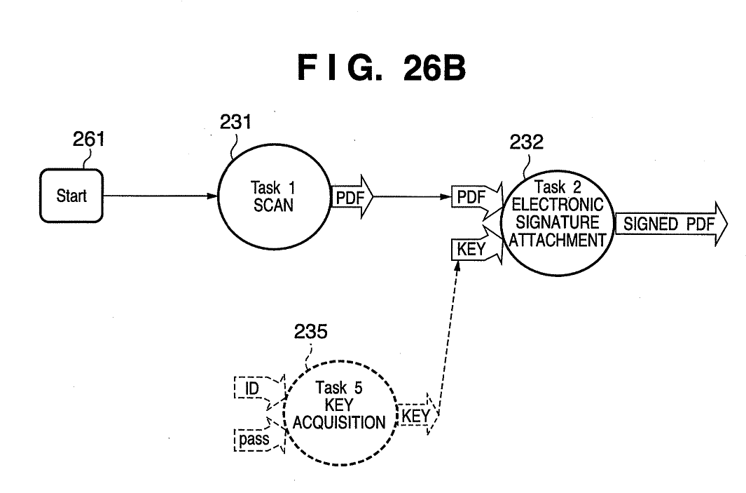

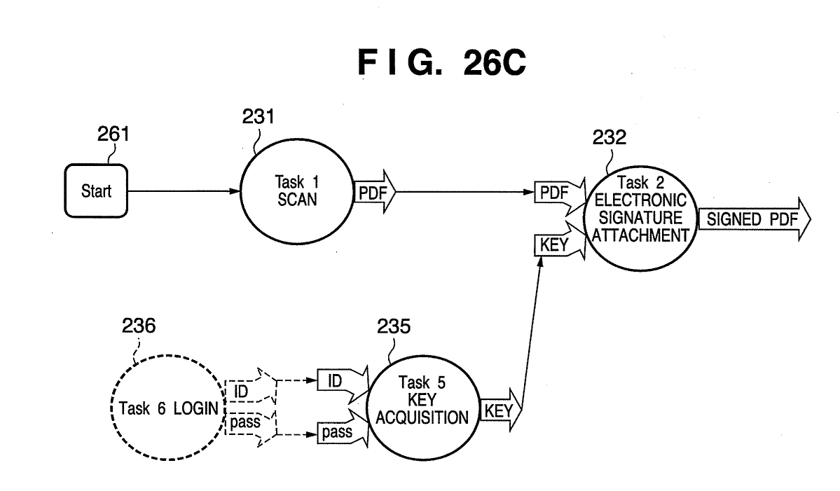

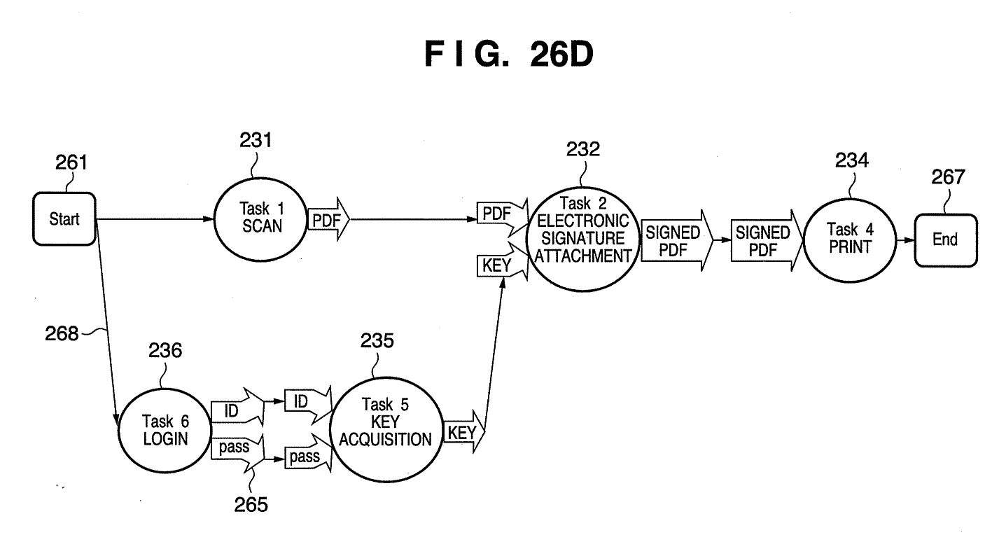

FIGS. 26A to 26D show job flow creation procedures in example 3. FIGS. 26A to 26D show creation procedures to define, as a job flow, a flow up to attachment of an electronic signature to scan data and printing of data by using the application shown in FIG. 22. Note that FIGS. 26A to 26D show an example of an operation in the job flow creation window 69 (FIGS. 6A and 6B) of the job flow creation editor.

In FIG. 26A, the job flow starts from a Start icon 261, and the task icon 231 of the scan task and the task icon 232 of the electronic signature attachment task are laid out. The electronic signature attachment task requires two input data: PDF data and key data. However, output data of the scan task (231) is only PDF data. When tasks up to the electronic signature attachment task (232) are laid out, input data go short, and no task can be laid out following the electronic signature attachment task (232). For this reason, as described in examples 1 and 2, a list of candidate tasks is displayed as shown in FIG. 26B. That is, when a task whose input data are short is laid out in the job flow creation window 69, a list of candidate tasks which have, as output data, data necessary as an input for the laid-out task and belong to the same category as that of the task is displayed. In example 3, the task icon 235 of the key acquisition task which has key data as output data and belongs to the electronic signature category 251 is displayed as a candidate. When the key acquisition task (235) is selected, the task icon 235 corresponding to the key acquisition task is finalized, as shown in FIG. 26C.

In example 3, the key acquisition task (235) which is displayed as a single candidate in FIG. 26B requires input data. When this task is selected, task candidates necessary to execute the selected task are displayed by the same method as that in FIG. 26B. In example 3, the task icon 236 corresponding to the login task belongs to the same category as that of the key acquisition task, and the output data type of the login task coincides with the input data type of the key acquisition task. Therefore, the login task is displayed as a candidate task, as shown in FIG. 26C. By selecting the login task (task icon 236), parallel processes for the electronic signature attachment task (232) are completed. FIG. 26D shows the result of creating a job flow containing merge of the parallel processes.

After the end of laying out tasks necessary to execute the electronic signature attachment task, the job flow creator lays out the print task following the electronic signature attachment task, and lays out an End icon 267, ending creation of the job flow. Note that the execution start point of the login task is set at the start point (268).

Processes corresponding to the operations shown in FIGS. 26A to 26D will be explained with reference to the flowcharts in FIGS. 12 and 13.

The job flow editor is activated, and the process in FIG. 12 starts. The task icon 231 of the scan task is laid out, and it is checked in step S2 whether input data of the scan task (231) go short. Since the scan task (231) requires “no” input data and input data do not go short, the process returns to step S1 to lay out the next task. Then, the task icon 232 of the electronic signature attachment task is laid out, and it is checked in step S2 whether input data of the electronic signature attachment task (232) go short, similar to the scan task. The electronic signature attachment task (232) requires PDF data and key data as input data, but the scan task (231) connected to the electronic signature attachment task (232) has only PDF data as output data. Therefore, input data of the electronic signature attachment task (232) go short by only the scan task (231), so the process advances from step S2 to step S3.

In step S3, the “task search & display & selection” process is executed. In this case, a candidate task is obtained from tasks belonging to a category to which the task (electronic signature attachment task) belongs. More specifically, in steps S103 to S106, a task which belongs to the same category (electronic signature category 251) as that of the electronic signature attachment task and has key data as output data is extracted. In this case, the key acquisition task (235) is extracted and displayed as a candidate task in step S107, as shown in FIG. 26B.

If the key acquisition task (235) is selected, it is determined whether this task requires input data (step S109). Since the key acquisition task (235) requires ID data and pass data, the flow advances to step S110 to recursively execute the “task search & display & selection” process for the key acquisition task.

As a result, the login task which belongs to the same category as that of the key acquisition task and has ID data and pass data as output data is displayed as candidate task (step S107). If the login task is selected, it does not require any input data, and “task search & display & selection” for the key acquisition task ends. Then, “task search & display & selection” for the electronic signature attachment task ends, and the process returns to step S1.

If the task icon 234 of the print task is laid out, the flow advances from step S1 to step S2 to check whether input data of the laid-out print task go short. In example 3, since the print task requires one input data and input data do not go short, the process returns to step S1. Thereafter, the End icon 267 is laid out, and the job flow creation process ends.

In the processes of steps S104 and S105 shown in FIG. 13, the number of short input data is one in FIGS. 11B, 20B, and 26B. In FIG. 26C, the key acquisition task (235) requires two input data, and the two input data go short. In the example of FIG. 26C, a task (login task) which belongs to the electronic signature category 251 and provides output data as the two input data is presented as a candidate task.

It is also possible to, when a plurality of input data go short, present, as a candidate task, a task containing some of the short input data. For the key acquisition task in FIG. 26C, a task which belongs to the electronic signature category 251 and contains ID data or pass data as output data may be presented as a candidate task.

For example, when input data A, B, and C go short, candidate tasks may be presented in order of (1) to (5). Note that presentation of candidate tasks in (1) to (5) is switched by a predetermined user operation.

(1) A task having A, B, and C as output data is presented as a candidate task.

(2) A task having A and B as output data, and a task having C as output data are presented as candidate tasks.

(3) A task having A and C as output data, and a task having B as output data are presented as candidate tasks.

(4) A task having B and C as output data, and a task having A as output data are presented as candidate tasks.

(5) A task having A as output data, a task having B as output data, and a task having C as output data are presented as candidate tasks.

The task cooperation system according to the above embodiment can achieve the following effects in creating a job flow containing complicated processes.

Since a connectable candidate task for compensating for shortage of input data is displayed, a target job flow can be easily created without paying attention to complicated parallel processes and connectivity between tasks.

Even for a task requiring a plurality of input data, a job flow can be created as easily as for a task requiring one input data.

It is expected that there are many tasks requiring a plurality of inputs among tasks in an application. In this case, it is difficult to create a job flow containing complicated parallel processes by paying attention to connectivity between tasks unless the user fully understands the application. However, the task cooperation system according to the embodiment can easily define a job flow containing parallel processes by presenting a connectable candidate task. It is significant to adopt the job flow creation method in the embodiment.

### Other Embodiment

The embodiment has been described in detail. The present invention can take an embodiment of a system, apparatus, method, program, storage medium, or the like. More specifically, the present invention may be applied to a system including a plurality of devices or an apparatus formed by a single device.

The above-described embodiment has exemplified tasks of the printing apparatus (e.g., copying of document data, scan, Fax transmission, save in the internal hard disk of the printing apparatus, and mail sending), and an application running in an externally cooperative information processing apparatus (e.g., personal computer). In this example, the job flow is formed by coupling tasks of the printing apparatus and process tasks of the application running in the information processing apparatus. However, the present invention is not limited to cooperation between the printing apparatus and the information processing apparatus, and may be applied to generation of a job flow in the single printing apparatus. The present invention may also be applied to a case where a job flow is formed by coupling processes tasks of applications running in a single or plurality of information processing apparatuses.

The present invention is also achieved by supplying a software program to a system or apparatus directly or from a remote place, and reading out and executing the supplied program codes by the computer of the system or apparatus. In this case, the supplied program corresponds to the flowcharts shown in the drawings.

The present invention is therefore implemented by program codes installed in the computer in order to implement functional processes of the present invention by the computer. That is, the present invention includes a computer program for implementing functional processes of the present invention.

In this case, the present invention can take any form such as an object code, a program executed by an interpreter, or script data supplied to an OS as long as a program function is attained.

A recording medium for supplying the program includes a floppy® disk, hard disk, optical disk, magnetooptical disk, MO, CD-ROM, CD-R, CD-RW, magnetic tape, nonvolatile memory card, ROM, and DVD (DVD-ROM and DVD-R).

As another program supply method, the program can be supplied by connecting a client computer to an Internet Web page via the browser of the client computer, and downloading the computer program of the present invention from the Web page to a recording medium such as a hard disk. The downloaded program may be a compressed file containing an automatic installing function. The program can also be implemented by grouping program codes which form the program of the present invention into a plurality of files, and downloading the files from different Web pages. That is, the present invention also includes a WWW server which allows a plurality of users to download the program files for implementing functional processes of the present invention by a computer.

The program of the present invention can be encrypted, stored in a recording medium such as a CD-ROM, and distributed to the user. In this case, a user who satisfies predetermined conditions is prompted to download decryption key information from a Web page via the Internet. The user executes the encrypted program using the key information, and installs the program in the computer.

The functions of the above-described embodiment are implemented when the computer executes the readout program codes. Also, the functions of the above-described embodiment are implemented when an OS or the like running on the computer performs some or all of actual processes on the basis of the instructions of the program codes.

The functions of the above-described embodiment are implemented when the program read out from the recording medium is written in the memory of a function expansion board inserted into the computer or the memory of a function expansion unit connected to the computer. In this case, after the program is written in the function expansion board or function expansion unit, the CPU of the function expansion board or function expansion unit performs some or all of actual processes on the basis of the instructions of the program codes.

According to the present invention, a complicated job flow to continue, after parallel processes, a process using a plurality of results obtained by the parallel processes can be easily created.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-228474, filed on Aug. 5, 2005, which is hereby incorporated by reference herein in its entirety.

What is claimed is:

1. An information processing apparatus which generates a flow by coupling a plurality of processes, comprising:
a registration unit adapted to register process information for defining input data and output data of each of the plurality of processes;
a setting unit adapted to set one of the plurality of processes as a set process in order to generate a flow;
an acquisition unit adapted to acquire, as candidate processes from the plurality of processes, processes capable of outputting input data of the set process by referring to the process information;
a presenting unit adapted to present the candidate processes acquired by said acquisition unit; and
a connection unit adapted to connect a selected candidate process as a process at a previous stage of the process in accordance with an operation to select one of the candidate processes presented by said presenting unit.

2. The apparatus according to claim 1, wherein
said setting unit sets one of the plurality of processes as a process following the set process, and
said acquisition unit comprises
a determination unit adapted to determine, by referring to the process information, whether input data of the process set by said setting unit go short, and
a selection unit adapted to, when said determination unit determines that the input data go short, select, as a candidate process from the plurality of processes by referring to the process information, a process capable of outputting the short input data.

3. The apparatus according to claim 2, wherein
the process information contains category information representing a category to which each process belongs, and
when said determination unit determines that input data go short, said acquisition unit refers to the process information and acquires, as a candidate process, a process which belongs to the same category as a category of the set process and can output the short input data.

4. The apparatus according to claim 2, wherein
the process information contains category information representing a category to which each process belongs,
said registration unit registers hierarchical information representing a hierarchical structure of categories, and
when said determination unit determines that input data go short, said acquisition unit refers to the process information and the hierarchical information, and acquires, as a candidate process, a process which belongs to the same category as a category of the set process or an upper category of the category and can output the short input data.

5. The apparatus according to claim 1, wherein when not less than two input data go short in the set process, said acquisition unit acquires, as a candidate process, a process having output data corresponding to all the short input data.

6. The apparatus according to claim 1, wherein when not less than two input data go short in the set process, said acquisition unit acquires, as a candidate process, a process having output data corresponding to some of the short input data.

7. The apparatus according to claim 3, wherein the process information permits one process to belong to a plurality of categories.

8. The apparatus according to claim 1, wherein when the process selected from the candidate processes presented by said presenting unit requires input data, said acquisition unit, said presenting unit, and said connection unit are caused to function in consideration that the input data of the selected process go short.

9. An information processing method of generating a flow by coupling a plurality of processes, comprising the steps of:
setting one of the plurality of processes as a set process by referring to a memory in which process information for defining input data and output data of each of the plurality of processes is registered, in order to generate a flow;
acquiring, as candidate processes from the plurality of processes, processes capable of outputting input data of the set process by referring to the process information;
presenting the candidate processes acquired in the acquisition step; and
a connection step of connecting a selected candidate process as a process at a previous stage of the process in accordance with an operation to select one of the candidate processes presented in the presenting step.

10. The method according to claim 9, wherein
in the setting step, one of the plurality of processes is set as a process following the set process, and
the acquisition step comprises the steps of:
determining, by referring to the process information, whether input data of the set process go short; and
selecting, when the input data are determined in the determination step to go short, as a candidate process from the plurality of processes by referring to the process information, a process capable of outputting the short input data.

11. The method according to claim 10, wherein
the process information contains category information representing a category to which each process belongs, and
in the acquisition step, when input data are determined in the determination step to go short, a process which belongs to the same category as a category of the set process and can output the short input data is acquired as a candidate process by referring to the process information.

12. The method according to claim 10, wherein
the process information contains category information representing a category to which each process belongs,
the memory registers hierarchical information representing a hierarchical structure of categories, and
in the acquisition step, when input data are determined in the determination step to go short, a process which belongs to the same category as a category of the set process or an upper category of the category and can output the short input data is acquired as a candidate process by referring to the process information and the hierarchical information.

13. The method according to claim 9, wherein in the acquisition step, when not less than two input data go short in the set process, a process having output data corresponding to all the short input data is acquired as a candidate process.

14. The method according to claim 9, wherein in the acquisition step, when not less than two input data go short in the set process, a process having output data corresponding to some of the short input data is acquired as a candidate process.

15. The method according to claim 11, wherein the process information permits one process to belong to a plurality of categories.

16. The method according to claim 9, wherein when the process selected from the candidate processes presented in the presenting step requires input data, the acquisition step, the presenting step, and the connection step are caused to function in consideration that the input data of the selected process go short.

17. A computer-executable program stored in a computer readable medium, the program for implementing an information processing method of generating a flow by coupling a plurality of processes, the information processing method comprising the steps of:
setting one of the plurality of processes as a set process by referring to a memory in which process information for defining input data and output data of each of the plurality of processes is registered, in order to generate a flow;
acquiring, as candidate processes from the plurality of processes, processes capable of outputting input data of the set process by referring to the process information;
presenting the candidate processes acquired in the acquisition step; and
a connection step of connecting a selected candidate process as a process at a previous stage of the process in accordance with an operation to select one of the candidate processes presented in the presenting step.

18. A computer-executable program according to claim 17, wherein, in the information processing method,
in the setting step, one of the plurality of processes is set as a process following the set process, and
the acquisition step comprises the steps of:
determining, by referring to the process information, whether input data of the set process go short; and
selecting, when the input data are determined in the determination step to go short, as a candidate process from the plurality of processes by referring to the process information, a process capable of outputting the short input data.
